(19) United States
(12) Patent Application Publication
(10) Pub. No.: US 2010/0165262 A1
(43) Pub. Date: Jul. 1, 2010

(54) OPTICAL LAMINATED FILM, METHOD FOR PRODUCING CONTINUOUS OPTICAL LAMINATED FILM, AND LIQUID CRYSTAL DISPLAY

(75) Inventors: Junichi Nagase, Ibaraki-shi (JP); Kazunori Futamura, Ibaraki-shi (JP); Hiroyuki Yoshimi, Ibaraki-shi (JP); Masaki Hayashi, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/440,293

(22) PCT Filed: Apr. 22, 2008
(86) PCT No.: PCT/JP2008/057717

§ 371 Date: Jun. 3, 2009

(30) Foreign Application Priority Data
May 10, 2007 (JP) 2007-125744

(51) Int. Cl. G02F 1/13363; G02B 1/08; B29C 47/06

(52) U.S. Cl. 349/96; 359/490; 156/243

(57) ABSTRACT

The optical laminated film of the present invention comprises a polarizer and a retardation film laminated on one surface of the polarizer, in which the polarizer has a drawn film of a hydrophilic polymer containing a dichroic material. An in-plane birefringence index (Δn_{xy}[1000]) of this polarizer at wavelength of 1000 nm is from 0.01 to 0.03, and the retardation film is a film such that an index ellipsoid satisfies the relation of nx>ny≧nz. The retardation film is disposed so that the slow axis direction of the retardation film is substantially orthogonal to the absorption axis direction of the above polarizer.

The optical laminated film of the present invention may increase contrast ratio in the case of being used for a liquid crystal display, for example.

### TECHNICAL FIELD

The present invention relates to an optical laminated film used for a liquid crystal display and the like, a method for producing thereof, and a liquid crystal display provided with the optical laminated film.

### BACKGROUND ART

A liquid crystal display is utilized for various uses while making use of characteristics thereof such as light weight, thin type, low power consumption, and the like. This is used for portable telephones, monitors, televisions, and the like for example. In recent years, for example, with regard to a liquid crystal display used for televisions, upsizing of the screen has rapidly progressed. For example, a liquid crystal television having a diagonal screen of 65-inch has been put to practical use. Under such a market trend, upsizing of an optical film utilized for the liquid crystal display has been urgent business.

An optical laminated film such that a polarizer and an optical compensation film composed of a drawn film of a thermoplastic polymer are laminated is known as one of optical films utilized for the liquid crystal display (Patent Document 1). This polarizer is typically produced in such a manner that a rolled polyvinyl alcohol film is dyed with a dichroic material and is uniaxially drawn in a longitudinal direction. With regard to such a polarizer, it is generally conceived that the film with higher draw ratio is more excellent in optical property. Such a polarizer is disclosed in Patent Document 2.

(Patent Document 1) Japanese Unexamined Patent Publication No. 2002-148437

(Patent Document 2) Japanese Unexamined Patent Publication No. 2004-341515

### DISCLOSURE OF THE INVENTION

However, when draw ratio is increased for obtaining a polarizer with high polarizing performance, effective width of the polarizer is narrowed by necking. Thus, it is difficult to obtain a polarizer appropriate for the above large-sized liquid crystal display.

Further, the liquid crystal display is generally low in contrast ratio in oblique directions. The above optical compensation film is used for improving this. However, in addition, an optical laminated film capable of further increasing contrast ratio of the liquid crystal display is demanded.

The object of the present invention is to provide an optical laminated film capable of increasing contrast ratio in the case of being used for a liquid crystal display. In addition, another object of the present invention is to provide an optical laminated film, which is also adaptable to a large-sized liquid crystal display. Further, another object of the present invention is to provide a method for producing the optical laminated film and a liquid crystal display provided with the optical laminated film.

An optical laminated film of the present invention comprises a polarizer, and a retardation film laminated on one surface of the polarizer. The polarizer has a drawn film of a hydrophilic polymer containing a dichroic material, and an in-plane birefringence index (Δn_{xy[}1000]) of the polarizer at wavelength of 1000 nm is from 0.01 to 0.03. The retardation film is such that an index ellipsoid satisfies a relation of nx>ny≧nz and is disposed so that a slow axis direction of the retardation film is substantially orthogonal to an absorption axis direction of the polarizer.

According to another aspect of the present invention, the present invention provides a method for producing a continuous optical laminated film. The method for producing the continuous optical laminated film of the present invention comprises the following steps 1 to 3.

The step 1: a step of drawing a continuous film (A) of a hydrophilic polymer containing a dichroic material to produce a continuous polarizer such that an in-plane birefringence index (Δn_{xy[}1000]) at wavelength of 1000 nm is from 0.01 to 0.03.

The step 2: a step of drawing a continuous film (B) at least in a width direction to produce a continuous retardation film such that an index ellipsoid satisfies a relation of nx>ny≧nz.

The step 3: a step of laminating the continuous retardation film obtained in the step 2 on one surface of the continuous polarizer obtained in the step 1 to produce the continuous optical laminated film.

For example, the above optical laminated film may be formed by die-cutting the continuous optical laminated film obtained by the above producing method.

The optical laminated film of the present invention has the polarizer having the in-plane birefringence index (Δn_{xy[}1000]) of from 0.01 to 0.03. The use of such an optical laminated film as a component member of a liquid crystal display may decrease light leakage of the liquid crystal display in oblique directions. Such a liquid crystal display is preferable, since the liquid crystal display has high contrast ratio in oblique directions.

The above polarizer having Δn_{xy[}1000] of from 0.01 to 0.03 may be produced by drawing the continuous film of the hydrophilic polymer containing the dichroic material, such as the above step 1. Examples of a method for making Δn_{xy[}1000] of this drawn film from 0.01 to 0.03 include methods for properly adjusting the content of the above dichroic material or performing the above drawing at low ratio.

Among them, the adoption of the method for performing the drawing at low ratio decreases the shrinkage of the drawn film in a width direction, so that a wide polarizer may be obtained.

On the other hand, the retardation film such that an index ellipsoid satisfies the relation of nx>ny≧nz may be produced by drawing the continuous film at least in the width direction, such as the above step 2. Thus, the retardation film becomes wide. Therefore, an optical laminated film obtained by laminating the wide polarizer and the wide retardation film may be formed into large area as compared with conventional laminated films. Such an optical laminated film may be used for a large-sized liquid crystal display, for example, a liquid crystal display having a diagonal screen of 70 inches or more.

As one preferable embodiment, a single transmittance of the polarizer is 42% or less and a degree of polarization of the polarizer is 98% or more.

As another preferable embodiment, the retardation film is a drawn film containing a norbornene-based polymer or a cellulose-based polymer.

As another preferable embodiment, an Nz coefficient of the retardation film is from 1.0 to 1.5.

As another preferable embodiment, the polarizer and the retardation film are laminated through an adhesive layer interposed therebetween.

### BRIEF DESCRIPTION OF THE DRAWINGS

FIG. 1A is a cross-sectional view showing one embodiment of a continuous optical laminated body. FIG. 1B is a cross-sectional view showing another embodiment of a continuous optical laminated body.

FIG. 2 is a reference drawing showing one example of producing steps for a continuous polarizer.

### BEST MODE FOR CARRYING OUT THE INVENTION

### Meaning of Terms

A polarizer signifies a film having the function of transmitting linearly polarized light mainly among natural light or polarized light. The polarizer has a transmission axis in a direction orthogonal to the absorption axis direction in the plane.

A retardation film signifies a film having birefringence (anisotropy of refractive index) in the plane and/or the thickness direction. The retardation film includes a retardation film having a birefringence index of 1×10⁻⁴ or more at wavelength of 590 nm in the plane and/or the thickness direction, for example.

The above described “nx” and “ny” signify refractive indexes in directions orthogonal to each other in the plane of the film (Here, nx≧ny), and “nz” signifies a refractive index in the thickness direction of the film.

“In-plane birefringence index (Δn_{xy}[λ])” signifies difference in the refractive index in the plane of the film measured at 23° C., with wavelength of λ(nm). The Δn_{xy}[λ] can be calculated by Δn_{xy}[λ]=nx−ny.

“In-plane retardation value (Re[λ])” signifies a retardation value in the plane of the film measured at 23° C., with wavelength of λ(nm). The Re[λ] can be calculated by Re[λ]=(nx−ny)×d. Here, the d (nm) signifies the thickness of the film.

“Retardation value in the thickness direction (Rth[λ])” signifies a retardation value in the thickness direction of the film measured at 23° C., with wavelength of λ(nm). The Rth[λ] can be calculated by Rth[λ]=(nx−nz)×d. Here, the d (nm) signifies the thickness of the film.

“Nz coefficient” signifies a value calculated by Rth[λ]/Re[λ]. In the present invention, the Nz coefficient signifies a value calculated by Rth[590]/Re[590] based on wavelength of 590 nm. The meanings of Rth[590] and Re[590] are as described above.

“Continuous” signifies that linear dimension is sufficiently larger than width dimension. The linear dimension is typically twice or more larger than the width dimension, and preferably 3 times or more.

“Film” includes those which are so-called sheet.

### <Overview of Optical Laminated Film>

An optical laminated film of the present invention has a polarizer and a retardation film laminated on one surface of the polarizer.

The polarizer is composed of a drawn film of a hydrophilic polymer containing a dichroic material. An in-plane birefringence index (Δn_{xy[}1000]) of the polarizer at wavelength of 1000 nm is from 0.01 to 0.03.

On the other hand, the retardation film is a film that an index ellipsoid satisfies the relation of nx>ny≧nz. The retardation film is disposed so that the slow axis direction of the retardation film is substantially orthogonal to the absorption axis direction of the polarizer and the retardation film is laminated on at least one surface of the polarizer.

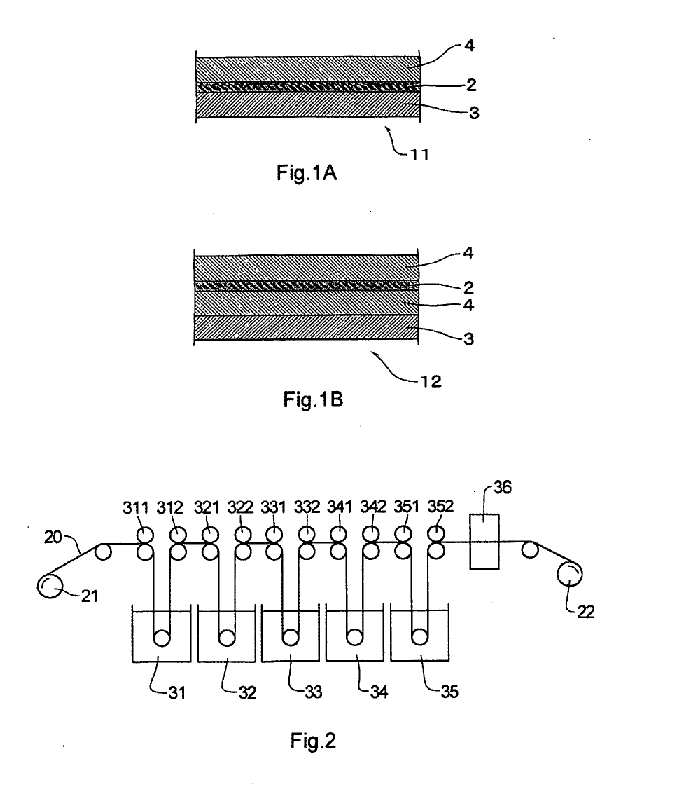

In one embodiment, as shown in FIG. 1A, with regard to an optical laminated film 11 of the present invention, a retardation film 3 is laminated on one surface of a polarizer 2. A transparent protective film 4 is laminated on the other surface of the polarizer 2.

In another embodiment, as shown in FIG. 1B, with regard to an optical laminated film 12 of the present invention, transparent protective films 4, 4 are laminated on both surfaces of a polarizer 2. A retardation film 3 is laminated on one surface of one of the protective films 4.

Each of layers of these films are adhered through an adhesive layer interposed therebetween as required (the adhesive layer is not shown). Another retardation film except the retardation film of the present invention may be laminated as required on the optical laminated films of the present invention. Furthermore, an optional layer such as an antiglare layer may be provided on a surface of the optical laminated films of the present invention.

The thickness of the optical laminated films of the present invention is not particularly limited, and yet preferably from 50 μm to 300 μm.

The optical laminated films of the present invention are incorporated into a liquid crystal display as one example of use. In this case, the side on which the retardation film of the present invention is laminated faces a liquid crystal cell (that is, so that the retardation film is interposed between a polarizer and a liquid crystal cell) to adhere the optical laminated films to the liquid crystal cell.

### (Polarizer)

The polarizer of the present invention is composed of a drawn film including a hydrophilic polymer containing a dichroic material.

Examples of the above dichroic material include such as iodine and dichromatic dyes. Examples of the above dichromatic dyes include such as red BR, red LR, red R, pink LB, rubin BL, bordeaux GS, sky blue LG, lemon yellow, blue BR, blue 2R, navy RY, green LG, violet LB, violet B, black H, black B, black GSP, yellow 3G, yellow R, orange LR, orange 3R, scarlet GL, scarlet KGL, congo red, brilliant violet BK, suprablue G, suprablue GL, supraorange GL, direct sky blue, direct first orange S and first black. These dichroic materials may be used singly or in combination of two or more kinds. Further, the dichroic materials are preferably soluble in water. For this reason, for example, organic dyes with a hydrophilic substituent introduced or the like are preferably used in a state of free acid and salt thereof. Examples of the above hydrophilic substituent include such as a sulfonic group, an amino group and a hydroxyl group. Examples of the above salt include such as an alkali metal salt, an ammonium salt and a salt of amines.

Among them, iodine is preferably used as the dichroic material. The use of iodine easily allows a polarizer exhibiting dichroic absorptivity to be obtained in approximately the whole range of visible light.

The above hydrophilic polymer film is not particularly limited. In general, the hydrophilic polymer film may be a film obtained by forming a resin composition containing a polymer having hydrophilic groups into a film Examples of the film include such as a polyvinyl-alcohol-based film (hereafter, polyvinyl alcohol will be denoted as “PVA”), a partially formalated PVA-based film, a polyethylene terephthalate, an ethylene-vinyl acetate copolymer-based film, and a partially saponified film of these. Furthermore, a polyene-based oriented film such as a dehydrated compound of PVA and a dehydrochlorinated compound of a polyvinyl chloride may be used. Among these, the film is preferably the PVA-based film since the film has excellent dyeability of a dichroic material. The PVA is a polymer obtained by saponifying polyvinyl acetate, wherein vinyl acetate is polymerized. The PVA-based polymer may be a modified PVA, which contains a component copolymerizable with vinyl acetate of PVA. Examples of the component copolymerizable with vinyl acetate of PVA include such as unsaturated carboxylic acid, olefin, vinyl ether, unsaturated sulfonate, derivative of these, α-olefin having from 2 to 30 carbons. Also, as examples of the PVA-based polymer, a modified PVA containing an acetoacetyl group, a sulfonic acid group, a carboxyl group, and the like; modified PVA such as polyvinyl formal, polyvinyl acetal, ethylene copolymer, and the like may be used.

The PVA-based polymer may be obtained by, for example, saponifying a vinyl-ester-based polymer. The vinyl-ester-based polymer may be obtained by polymerizing a vinyl ester-based monomer such as vinyl acetate. This PVA-based polymer is preferably a PVA-based polymer having a high saponification degree and a high polymerization degree in terms of obtaining a polymer good in heat resistance. A saponification degree of the PVA is not particularly limited, but for example, it is generally 90 mol % or more, preferably from 95 mol % or more, and more preferably from 98 mol % or more. The saponification degree can be calculated according to JIS K 6726-1994. For producing a polarizer having high polarizing performance, an average polymerization degree of the PVA is not particularly limited, but for example, it is generally 500 or more, and preferably 2,400 or more. The upper limit of the average polymerization degree is generally 8,000 or less, and preferably 5,000 or less. The average polymerization degree can be calculated according to JIS K 6726-1994.

The PVA-based film may be obtained by a casting method of dissolving a resin composition containing a PVA-based polymer into appropriate organic solvents, such as water and/or DMSO, and coating the resin solution onto an appropriate substrate. The PVA-based film may also be formed into a film by a known film-forming method such as an extruding method besides the casting method.

An appropriate additive such as a plasticizer or a surfactant may be blended with the resin composition containing the above PVA-based polymer. Examples of the plasticizer include polyalcohol such as ethylene glycol, glycerin, or the like. Examples of the surfactant include nonionic surfactant or the like. The addition of the plasticizer or the surfactant makes it possible to obtain a PVA-based film excellent in dyeability and drawability. The additive amount of each of the plasticizer and the surfactant is more than about 1 to 10 parts by mass with respect to 100 parts by mass of the PVA-based polymer, respectively.

The polarizer of the present invention is composed of a drawn film obtained by drawing a hydrophilic polymer film (preferably, a PVA-based film) containing the above dichroic material. Such a drawn film may be obtained, for example, through each treatment step such that the above hydrophilic polymer film is swelled, dyed and drawn.

Here, a method for producing the polarizer of the present invention is described in detail in the section of the following <Method for producing continuous optical laminated film>.

With regard to the polarizer of the present invention, an in-plane birefringence index (Δn_{xy[}1000]) at wavelength of 1000 nm is from 0.01 to 0.03. Here, the reason why wavelength of 1000 nm is determined at the standard is as follows. The polarizer typically has absorption in visible light range. For this reason, it is occasionally difficult that the in-plane birefringence index of the polarizer is measured by wavelengths in visible light range. However, a measuring wavelength of 1000 nm allows the in-plane birefringence index of the polarizer to be accurately measured.

With regard to the polarizer of the present invention, Δn_{xy[}1000] is in a range of from 0.01 to 0.03. For this reason, in the case of using the polarizer for a liquid crystal display, light leakage of the liquid crystal display in oblique directions may be decreased and the contrast ratio of the liquid crystal display in oblique directions may be increased. The function such that the polarizer of the present invention may improve the contrast ratio of the liquid crystal display is not definite, however, the inventors of the present invention presume as follows.

Generally, with regard to a polarizer composed of a drawn film of a hydrophilic polymer containing a dichroic material, an in-plane birefringence index (Δn_{xy[}1000]) thereof exceeds 0.03. However, with regard to the polarizer of the present invention, an in-plane birefringence index (Δn_{xy[}1000]) is lower than this. That is, Δn_{xy[}1000]=from 0.01 to 0.03. For this reason, in the polarizer of the present invention, a part of the dichroic material (iodine complex in the case of using iodine) existing between the aligned polymers is aligned in oblique directions to the alignment direction of the polymers. Therefore, it is presumed that the polarizer absorbs not merely light components parallel to the absorption axis of the polarizer but also light components not parallel thereto among transmitted light. For this reason, the polarizer of the present invention may decrease light leakage of the liquid crystal display in oblique directions and increase contrast ratio of the liquid crystal display in oblique directions.

The in-plane birefringence index of the polarizer of the present invention (Δn_{xy[}1000]) is preferably from 0.01 to 0.025, and more preferably from 0.01 to 0.02. The polarizer having such a Δn_{xy[}1000] can particularly improve contrast ratio of the liquid crystal display.

The in-plane retardation value (Re[1000]) of the polarizer of the present invention at wavelength of 1000 nm is preferably from 400 nm to 1000 nm, and more preferably from 500 nm to 900 nm.

The thickness of the polarizer of the present invention is properly set but it is preferably from 5 μm to 50 μm, and more preferably from 10 μm to 40 μm. The polarizer having such a thickness is comparatively thin type. Since the in-plane retardation value (Re[1000]) of the polarizer can be set in the above range.

Also, the single transmittance of the polarizer of the present invention is preferably 42% or less, and more preferably from 35% to 42%. The degree of polarization of the polarizer of the present invention is preferably 98% or more, and more preferably 99% or more.

The content of the dichroic material (preferably iodine) in the polarizer of the present invention is preferably from 2.9 to 5.5% by mass, and more preferably from 3.2 to 5.0% by mass. A polarizer having appropriate in-plane birefringence index can be obtained by setting the content of the dichroic material in this range, and the polarizer can improve contrast ratio of a liquid crystal display.

### (Retardation Film)

With regard to the retardation film of the present invention, an index ellipsoid satisfies the relation of nx>ny≧nz, and preferably satisfies the relation of nx>ny>nz. The retardation film has at least an in-plane retardation value. In the case of using this retardation film in a liquid crystal display, the contrast ratio of the liquid crystal display in oblique directions can be further increased.

Here, “index ellipsoid satisfies nx>ny≧nz” signifies nx>ny>nz or nx>ny=nz. This “ny=nz” includes not only the case where ny and nz are completely identical, but also the case where they are substantially identical. The case where ny and nz are substantially identical is for example the case that “Rth[590]-Re[590]” is from −10 nm to 10 nm, and preferably from −5 nm to 5 nm.

The in-plane retardation value (Re[590]) of the retardation film of the present invention at wavelength of 590 nm is preferably from 20 nm to 200 nm, and more preferably from 30 nm to 150 nm.

The Nz coefficient of the retardation film of the present invention is preferably from 1.0 to 1.5, and more preferably from 1.1 to 1.4.

The thickness of the retardation film of the present invention is properly designed but it is preferably from 20 μm to 200 μm. The in-plane retardation value (Re[590]) of the retardation film having such a thickness can be set in the above range.

In the case of being laminated on the above polarizer, the retardation film of the present invention is disposed so that the slow axis direction of the retardation film is substantially orthogonal to the absorption axis direction of the polarizer. Here, “substantially orthogonal” signifies that the angle made between the slow axis direction of the retardation film and the absorption axis direction of the polarizer includes 90°±2°. Further, the slow axis direction is a direction in which refractive index becomes the maximum in the plane.

The retardation film such that the index ellipsoid satisfies the relation of nx>ny≧nz may be obtained, for example, by drawing an undrawn film.

In a mechanical production process, an undrawn continuous film is typically drawn to produce a continuous retardation film, which is die-cut into a proper size. Here, in the present specification, “die-cut” includes the meaning of “cut out”.

In this case, the drawing of an undrawn continuous film at least in a width direction (TD direction) allows a continuous retardation film to be obtained such that the index ellipsoid thereof satisfies the relation of nx>ny≧nz and the slow axis thereof is developed in a direction orthogonal to the longitudinal direction (MD direction).

A film for forming the retardation film is not particularly limited as far as the index ellipsoid thereof satisfies the relation of nx>ny≧nz. Preferably, as the film, which forms the retardation film, the film containing the norbornene-based polymer or the cellulose-based polymer is used. By drawing these film, a continuous retardation film such that the index ellipsoid thereof satisfies the relation of nx>ny≧nz and the slow axis thereof is developed in a direction orthogonal to the longitudinal direction (MD direction) can be obtained.

As for the norbornene-based polymer, a norbornene-based monomer having a norbornene ring (having double bond in norbornane ring) is used as a starting material. The norbornene-based polymer may have a norbornane ring or may not have a norbornane ring as a constituent unit in a (co)polymer state. Examples of the norbornene-based polymer having a norbornane ring as a constituent unit in a (co)polymer state include tetracyclo[4.4.1^{2,5}.1^{7,10}.0]deca-3-ene, 8-methyltetracyclo[4.4.1^{2,5}.1^{7,10}.0]deca-3-ene, 8-methoxycarbonyltetracyclo[4.4.1^{2,5}.1^{7,10}0]deca-3-ene, and the like. Examples of the norbornene-based polymer not having a norbornane ring as a constituent unit in a (co)polymer state include the (co)polymer obtained by using a monomer that becomes 5-membered ring as a result of cleavage. Examples of the monomer that becomes 5-membered ring as a result of cleavage include such as norbornene, dicyclopentadiene, 5-phenylnorbornene, and derivatives thereof. When the norbornene-based polymer is a copolymer, alignment condition of the molecules is not particularly limited, and it may be a random copolymer, a block copolymer, or a graft copolymer.

Examples of the norbornene-based polymer include (a) a polymer obtained by hydrogenating a ring-opened (co)polymer made from a norbornene-based monomer; (b) a polymer obtained by addition-(co)polymerizing a norbornene-based monomer; or the like. The ring-opened copolymer (a), which is made from a norbornene-based monomer, includes a polymer obtained by hydrogenating a ring-opened copolymer made from one or more norbornene-based monomers, and α-olefin, cycloalkene and/or non-conjugated diene. The polymer (b), which is obtained by addition-copolymerizing a norbornene-based monomer, includes a polymer obtained by addition-copolymerizing one or more norbornene-based monomers, and α-olefin, cycloalkene and/or non-conjugated diene.

The polymer (a), which is obtained by hydrogenating a ring-opened (co)polymer made from a norbornene-based monomer, can be yielded by causing the norbornene-based monomer and so on to react for metathesis so as to yield the ring-opened (co)polymer, and then hydrogenating the ring-opened (co)polymer. Specifically, the polymer (a) may be obtained by methods described in, for example, paragraphs [0059] to [0060] in JP-A-11-116780, paragraphs [0035] to [0037] in JP-A-2001-350017, and others. The polymer (b), which is obtained by addition-(co)polymerizing a norbornene-based monomer, can be yielded by a method described in Example 1 in JP-A-61-292601.

The weight-average molecular weight (Mw) of the norbornene-based polymer is preferably from 20,000 to 500,000. Here, the weight-average molecular weight (Mw) refers to a value measured by gel permeation chromatography method (GPC) using a tetrahydrofuran solvent. The glass transition temperature (Tg) of the norbornene-based polymer is preferably from 110° C. to 180° C. Here, the glass transition temperature (Tg) refers to a value calculated by DSC method according to JIS K 7121. By setting the weight-average molecular weight and the glass transition temperature in the above range, a film good in hear resistance and drawability can be obtained.

A cellulose-based polymer substituted with an acetyl group and/or a propionyl group is preferably used for the above cellulose-based polymer. A cellulose-based polymer such that degree of acetyl substitution (DSac) and degree of propionyl substitution (DSpr) satisfy the relational expression of 2.0≦(DSac+DSpr)≦3.0 is preferably used for the above cellulose-based polymer. The lower limit value of DSac+DSpr is preferably 2.3, and more preferably 2.6. The upper limit value of DSac+DSpr is preferably 2.9, and more preferably 2.8. A liquid crystal display excellent in display properties may be constituted by making DSac+DSpr of the above cellulose-based film in this range. A cellulose-based polymer such that degree of propionyl substitution (DSpr) satisfies the relational expression of 1.0≦DSpr≦3.0 is used for the above cellulose-based polymer. The lower limit value of DSpr is preferably 2, and more preferably 2.5. The upper limit value of DSpr is preferably 2.9, and more preferably 2.8. Here, degree of acetyl substitution (DSac) and degree of propionyl substitution (DSpr) may be measured by the method described in [0016] to [0019] of JP-A-2003-315538.

The above cellulose-based polymer may have another substituent except an acetyl group and a propionyl group. Examples of other substituents include an ester group such as butyrate; ether groups such as an alkyl ether group and an alkylene ether group; and the like.

The weight-average molecular weight (Mw) of the above cellulose-based polymer is preferably from 20,000 to 500,000. The glass transition temperature (Tg) of the above cellulose-based polymer is preferably from 120° C. to 170° C. The above polymer allows a film to be obtained having excellent thermal stability and excellent in drawability.

### <Method for Producing Continuous Optical Laminated Film>

The optical laminated film of the present invention may be obtained, for example, by die-cutting a continuous optical laminated film into a proper size.

The continuous optical laminated film may be produced through the following step 1 to step 3, for example. Here, another step in addition to the step 1 to the step 3 may be included in the production of the continuous optical laminated film of the present invention. Further, the performing order of the step 1 and the step 2 is not particularly limited, but the step 1 may be previously performed, the step 2 may be previously performed, or the step 1 and the step 2 may be concurrently performed.

### (Step 1)

The step 1 is a step of drawing a continuous film (A) of a hydrophilic polymer containing a dichroic material to produce a continuous polarizer such that an in-plane birefringence index (Δn_{xy[}1000]) at wavelength of 1000 nm is from 0.01 to 0.03.

The step 1 preferably includes swelling treatment for swelling an undrawn continuous film (A), dyeing treatment for making the continuous film (A) contain a dichroic material, crosslinking treatment for crosslinking the polymer of the continuous film (A), drawing treatment for drawing the continuous film (A), cleaning treatment for cleaning the continuous film (A) and drying treatment for drying the continuous film (A).

A specific example of the above step 1 is described by referring to FIG. 2. FIG. 2 is a schematic view showing a concept of a typical producing step for a continuous polarizer.

In FIG. 2, a continuous film 20 wound up into a roll is reeled out of a delivery portion 21. Next, the continuous film 20 is immersed in a swelling bath 31 containing pure water and a dyeing bath 32 containing such as iodine, and is subjected to swelling treatment and dyeing treatment while tension is applied in a film longitudinal direction by rolls 311, 312, 321 and 322 having different velocity ratios. Next, the continuous film 20 subjected to swelling treatment and dyeing treatment is immersed in a first crosslinking bath 33 and a second crosslinking bath 34 containing such as potassium iodide, and is subjected to crosslinking treatment and final drawing treatment while tension is applied in a film longitudinal direction by rolls 331, 332, 341 and 342 having different velocity ratios. The continuous film 20 subjected to crosslinking treatment is immersed in a washing bath 35 containing pure water by rolls 351 and 352, and is subjected to washing treatment. The film 20 subjected to washing treatment is dried by a drying means 36. The moisture percentage of the film 20 is adjusted, for example, from 10% to 30% by drying. Finally, the film 20 is wound up by a take-up portion 22.

### (Swelling Treatment)

The swelling treatment is a step of swelling an undrawn continuous film (A).

As the continuous film (A), a continuous film made by forming a resin composition containing a hydrophilic polymer into a film form is used. As the hydrophilic polymer film, the film described in the section of the above (Polarizer) can be used, and the film is preferably the PVA-based film.

The production process using the continuous film (A) made of the PVA-based film will be mainly described hereinafter. However, the continuous polarizer of the present invention is not limited to the production using the PVA-based film, and may be applied also to another different hydrophilic polymer films.

An undrawn film is used for the above continuous film (A). The thickness of the continuous film (A) is preferably from 30 μm to 100 μm.

The continuous film (A) may also be in the roll shape. The winding length of the continuous film (A) is preferably 300 m or more, and more preferably from 1,000 m to 50,000 m.

As the continuous film (A) containing PVA-based polymer as the main component, for example, a commercially available film may be used as it is. Examples of the commercially available PVA-based film include “KURARAY VINYLON FILM (trade name)” manufactured by Kuraray Co., Ltd., “TOHCELLO VINYLON FILM (trade name)” manufactured by Tohcello Co., Ltd., “NICHIGOU VINYLON (trade name)” manufactured by Nippon Synthetic Chemical Industry Co., Ltd., or the like.

The swelling treatment is a step for removing stains on the surface of the continuous film and further swelling the continuous film with water. By the swelling treatment, introduction unevenness of the dichroic material, that will be described later, can be prevented.

The swelling bath is full with water. As far as the effects of the present invention are not damaged, any other material may be added to the solution in the swelling bath. The solution temperature of the swelling bath is preferably a temperature of about 20 to 50° C., and more preferably a temperature of about 30 to 40° C. The period when the continuous film is immersed in the swelling bath is from about 1 to 7 minutes. Water used in the swelling bath, a dyeing bath that will be described later, and other baths is preferably pure water.

### (Dyeing Treatment)

The dyeing treatment is a step of impregnating (also referred to as absorbing or contacting) the swelled continuous film (A) with a dichroic material.

The dyeing bath is full with a dyeing solution containing water and a dichroic material dissolved in the water. Here, in the dyeing solution, an organic solvent compatible with water may be added a little.

The dichroic material used in the present invention may be the material described in the section of the above (Polarizer), and is preferably iodine.

In the dyeing bath, the additive amount of the dichroic material (for example, iodine) is preferably from 0.01 to 0.15 parts by mass, and more preferably from 0.01 to 0.05 parts by mass with respect to 100 parts by mass of water. By setting the additive amount in the above range, a continuous polarizer having Δn_{xy[}1000] of from 0.01 to 0.03 can be obtained.

The single transmittance of the above continuous polarizer may be properly increased or decreased by adjusting the additive amount of a dichroic material. For example, the single transmittance of the obtained continuous polarizer is lowered by increasing the additive amount of a dichroic material. On the other hand, the single transmittance of the obtained continuous polarizer is raised by decreasing the additive amount of a dichroic material.

An iodide may be further added to the dyeing bath. Examples of the iodide include potassium iodine, lithium iodide, sodium iodide, zinc iodide, aluminum iodide, lead iodide, copper iodide, barium iodide, calcium iodide, tin iodide, titanium iodide, or the like. The iodide is preferably potassium iodide. The additive amount of the iodide is preferably from 0.05 to 0.5 parts by mass, and more preferably from 0.1 to 0.3 parts by mass with respect to 100 parts by mass of water. When the additive amount of the iodide is set in the above range, a polarizer having a preferable single transmittance and a high degree of polarization can be obtained.

The period when the continuous film (A) is immersed in the dyeing bath is not particularly limited, and is preferably from about 20 to 1,800 seconds. The solution temperature of the dyeing bath is preferably from about 20° C. to 60° C., and more preferably from about 30° C. to 50° C. If the temperature of the dyeing bath is too high, the film (A) may be unfavorably melted. If the temperature is too low, the dyeability may fall. The dyeing step may be performed in two or more separated dyeing baths.

The continuous film (A) may be drawn in the dyeing bath(s). At this time, the draw ratio in the dying bath(s) is from about 1.5 to 3.0 times.

### (Crosslinking Treatment)

The crosslinking treatment is a step of impregnating the continuous film (A), which is impregnated with the dichroic material, with a crosslinking agent such as boric acid. The crosslinking bath may be one bath or two or more baths.

The crosslinking bath is full with a crosslinking solution containing a crosslinking agent dissolved in water. As the crosslinking agent, for example, boron compounds such as boric acid, borax, or the like is cited. These may be used only one kind or in combination of two or more kinds of them. However, the crosslinking agent preferably includes at least boric acid.

The additive amount of the crosslinking agent in the crosslinking bath is not particularly limited, and is preferably from 0.5 to 10 parts by mass, and more preferably from 1 to 7 parts by mass with respect to 100 parts by mass of water.

Further, in the crosslinking bath, an iodide (for example, potassium iodide) may be added. The additive amount of the iodide is preferably from 0.5 to 10 parts by mass, and more preferably from 1 to 7 parts by mass with respect to 100 parts by mass of water. By setting the additive amount of the boron compounds and the iodide in the above range, a polarizer having preferably single transmittance and high degree of polarization can be obtained.

The solution temperature of the crosslinking bath is not particularly limited, and is preferably from 20° C. to 70° C. The period when the film (A) is immersed therein is not particularly limited, and is preferably from about 60 to 1,200 seconds, and more preferably from about 200 to 400 seconds.

Further, the continuous film (A) may be drawn in this crosslinking bath. In this case, the draw ratio in the crosslinking bath is from about 2 to 4 times.

The drawing treatment is performed by drawing a undrawn continuous film (A) (a continuous film (A) before swelling treatment is performed) from about 3 to 5 times, preferably from 4 to 5 times, and more preferably from 4.2 to 4.8 times longer than the original length thereof. Here, in the case where the film is subjected to the drawing treatment in two or more steps, the draw ratio suggested herein signifies the total draw ratio obtained by summing up draw ratios in the all steps.

A continuous polarizer such that Δn_{xy[}1000] is from 0.01 to 0.03 may be obtained by making such draw ratio in the above range. The continuous film (A) obtained at such draw ratio has a dichroic material (iodine complex in the case of using iodine) aligned in oblique directions. The use of the continuous film (A) as a polarizer of a liquid crystal panel may effectively prevent light leakage of the liquid crystal panel in oblique directions.

The drawing is performed in the drawing treatment so that the neck-in ratio (NR) of the continuous film (A) is preferably 55% or less, more preferably 50% or less and particularly preferably from 35% to 50%. The continuous film (A) after being drawn is comparatively widened by making the neck-in ratio at 50% or less. As described above, the continuous film (A) having such neck-in ratio may be produced by comparatively lowering draw ratio (3 to 5 times).

Here, in the present specification, the neck-in ratio (NR) is calculated by the following expression; NR={(Wo−W)/Wo}×100 when the width of an undrawn film and the width of the film after being drawn is regarded as Wo and W, respectively. The above neck-in ratio may be properly increased or decreased by adjusting draw ratio and/or distance between rolls in the case of adopting roll method drawing. For example, the decrease of draw ratio and/or distance between rolls decreases the neck-in ratio, while the increase of draw ratio and/or distance between rolls increases the neck-in ratio.

The above in-plane birefringence index (Δn_{xy[}1000]) may be controlled to a proper numerical value by changing the draw ratio of the continuous film (A) and/or the content of a dichroic material (preferably iodine) in the continuous film. For example, the continuous film (A) having comparatively low Δn_{xy[}1000] may be obtained by comparatively lowering the draw ratio of the continuous film (A). On the other hand, the continuous film (A) having comparatively high Δn_{xy[}1000] may be obtained by decreasing the content of a dichroic material in the continuous film (A) (that is, raising the single transmittance of the film), while the continuous film (A) having comparatively low Δn_{xy[}1000] may be obtained by increasing the content of a dichroic material in the continuous film (A).

### (Washing Treatment)

The washing treatment is a step of washing away unnecessary remnants such as boron adhering to the continuous film (A) that has undergone the above individual steps.

The crosslinked continuous film (A) is pulled out from the crosslinking bath, and then introduced into a washing bath.

The washing bath is full with water, and the bath may be added a proper additive as necessary.

The solution temperature of the washing bath is preferably from about 10° C. to 60° C., and more preferably from about 15° C. to 40° C. The number of treatments for the washing is not particularly limited, and the washing treatment can be conducted in plural numbers.

### (Drying Treatment)

The drying treatment is a step of drying the washed continuous film (A).

The washed continuous film (A) is pulled out from the washing bath, and then dried.

For the drying, an appropriate method may be used. Examples of the method include natural drying, wind drying, drying by heating, or the like. In general, drying by heating is preferably used. In the drying by heating, for example, the temperature of heating is preferably from about 20 to 80° C., and the period of drying is preferably from about 1 to 10 minutes.

The continuous polarizer obtained by the above step 1 is a drawn film obtained by drawing the continuous film (A) containing the dichroic material as described above. The thickness of the continuous polarizer is preferably from 5 μm to 50 μm, and more preferably from 10 μm to 40 μm.

In the case where the continuous polarizer (continuous film (A)) is dyed with iodine, the content of iodine of the continuous polarizer is preferably from 2.9 to 5.5% by mass, and more preferably from 3.2 to 5.0% by mass.

Furthermore, the continuous polarizer may contain potassium. In the case where the continuous polarizer contains potassium, the content of potassium of the continuous polarizer is preferably from 0.2 to 1.2% by mass, and more preferably from 0.3 to 1.2% by mass. By setting the content of potassium in the above range, a polarizer having preferably single transmittance and degree of polarization can be obtained.

Also, the continuous polarizer may preferably contain boron. In the case where the continuous polarizer contains boron, the content of boron of the continuous polarizer is preferably from 0.5 to 3.0% by mass, and more preferably from 1.0 to 2.8% by mass. By setting the content of boron in the above range, a polarizer having preferable single transmittance and degree of polarization can be obtained.

Here, with regard to the above continuous polarizer, a protective film excellent in transparency may be adhered on one surface or both surfaces thereof as required. Examples of the protective film include such as a triacetylcellulose film.

### (Step 2)

The step 2 is a step in which a continuous film (B) is drawn at least in a width direction to produce a continuous retardation film such that an index ellipsoid satisfies the relation of nx>ny≧nz.

A norbornene-based polymer film or a cellulose-based polymer film is preferably used as the continuous film (B). The film described in the above section (the retardation film) may be used as the continuous film (B). With regard to the continuous film (B), an undrawn film is typically used and uniaxial or biaxial drawing may be somewhat performed.

The continuous film (B) may be in the roll shape. The winding length of the continuous film (B) is preferably 300 m or more, and more preferably from 1,000 in to 50,000 m.

A method for drawing the continuous film (B) is not particularly limited as far as the film is drawn at least in a width direction (TD direction). As the drawing method, for example, transverse uniaxial drawing method, longitudinal and transverse biaxial simultaneous drawing method, or longitudinal and transverse biaxial successive drawing method may be cited. The temperature when the continuous film (B) is drawn is preferably from 120° C. to 200° C. Also, the draw ratio of the continuous film (B) is preferably more than 1 and 3 times or less.

By the drawing treatment, a continuous film (B) such that an index ellipsoid thereof satisfies the relation of nx>ny≧nz can be obtained. The drawn continuous film (B) may be used as a continuous retardation film.

As described above, the continuous retardation film is obtained by drawing the continuous film (B) at least in a width direction. Therefore, the continuous retardation film has a longer width than an original width (a width before drawing) of the continuous film (B). For this reason, a wide retardation film such that an index ellipsoid thereof satisfies the relation of nx>ny≧nz can be produced.

### (Step 3)

The step 3 is a step in which the continuous retardation film obtained in the above step 2 is laminated on one surface of the continuous polarizer obtained in the above step 1 to produce a continuous optical laminated film.

The above continuous polarizer and continuous retardation film are disposed so that the slow axis direction of the continuous retardation film is substantially orthogonal to the absorption axis direction of the continuous polarizer.

With regard to the continuous polarizer obtained in the above step 1, the absorption axis is developed in a direction approximately parallel to a longitudinal direction thereof. On the other hand, with regard to the continuous retardation film obtained in the above step 2, the slow axis is developed in a direction approximately orthogonal to a longitudinal direction thereof. For this reason, in the step 3, the continuous polarizer and the continuous retardation film are each drawn out in the longitudinal direction, superposed and adhered in a lamination (so-called roll-to-roll adhesion). This method allows the above continuous optical laminated film to be obtained, which is laminated so that the slow axis direction of the continuous retardation film is substantially orthogonal to the absorption axis direction of the continuous polarizer. The continuous optical laminated film of the present invention may adopt such a roll-to-roll adhesion method, so that productivity thereof is greatly improved.

The optical laminated film of the present invention may be produced by die-cutting the above continuous optical laminated film into a proper shape.

Here, the continuous polarizer and the continuous retardation film are preferably adhered through an adhesive layer. In the present specification, “adhesive layer” signifies a layer that bonds both surfaces of neighboring members to integrate these members with each other by practically sufficient adhesive force in a practically adequate adhering time. As examples of materials forming the adhesive layer, adhesive agents, pressure sensitive adhesive agents and anchor coating agents are cited. The above adhesive layer may have a multilayer structure in which an anchor coating agent is formed on the surface of a body to be coated and an adhesive layer or a pressure sensitive adhesive layer is formed on the anchor coating agent. The adhesive layer may be a thin layer as is not discernible with the naked eye (also referred to as a hairline).

### (Another Step)

The producing method of the present invention may further include the following step 4 after the above step 3.

The step 4 is a step in which the continuous optical laminated film obtained in the above step 3 is die-cut into a rectangle to produce a rectangular optical laminated film.

A rectangular optical laminated film may be produced by die-cutting the above continuous optical laminated film into a rectangle. A Thomson blade is typically used for this processing. The above rectangular optical laminated film is used as a component member of a liquid crystal display, for example. The length of a diagonal line of the rectangular optical laminated film is preferably 70 inches or more, more preferably 80 inches or more and particularly preferably 100 inches or more.

As described above, both the continuous polarizer and the continuous retardation film are so wide films that the continuous optical laminated film obtained by laminating these is also wide. Accordingly, the present invention also allows a large-area and rectangular optical laminated film to be obtained which is capable of corresponding to a liquid crystal display having a diagonal screen of 70 inches or more, for example.

The above rectangular optical laminated film is preferably die-cut so that the long side direction thereof is substantially parallel to the absorption axis direction of the laminated polarizer. The above rectangular optical laminated film is particularly preferably die-cut so that the long side direction thereof is substantially orthogonal to the absorption axis direction of the laminated polarizer. Such a rectangular optical laminated film is preferably disposed on the backlight side of a liquid crystal cell. Here, in the present specification “substantially parallel” includes a case where an angle formed by the long side direction and the absorption axis direction is 0°±2° and preferably 0°±1°. In the present specification, “substantially orthogonal” includes a case where an angle formed by the long side direction and the absorption axis direction is 90°±2° and preferably 90°±1°.

### <Application of Optical Laminated Film and the Like>

The optical laminated film of the present invention is mounted on an apparatus as a construction element thereof. Examples of the apparatus include office automation equipments such as a personal computer monitor, a notebook computer and a copying machine; portable equipments such as a portable telephone, a watch, a digital camera, a personal digital assistant (PDA) and a portable game machine; domestic electrical equipments such as a video camera, a television set and a microwave oven; on-vehicle equipments such as a back monitor, a monitor for a car navigation system and a car audio; display equipments such as an information monitor for a commercial store; security equipments such as an observation monitor; and care/medical equipments such as a care monitor and a medical monitor.

Preferably, the optical laminated film is mounted on a television set. The screen size (a length of diagonal line of the rectangular screen) of the television set is preferably 70 inches or more, more preferably 80 inches or more, and particularly preferably 100 inches or more.

### EXAMPLES

The present invention will be further described by way of Examples and Comparative Example. Here, the present invention is not limited only to the following Examples. Individual analyzing methods used in Examples and Comparative Example are as follows.

### (1) Method for Measuring Single Transmittance:

The single transmittance (T) was measured by using a spectrophotometer [product name: “DOT-3”, manufactured by Murakami Color Research Laboratory Co., Ltd.]. The single transmittance is the Y value of tristimulus values based on the two-degree field according to JIS Z 8701-1995.

### (2) Method for Measuring Degree of Polarization of Polarizer:

A spectrophotometer [product name: “DOT-3”, manufactured by Murakami Color Research Laboratory Co., Ltd.] was used to measure the parallel transmittance (H₀) of any polarizer, and the orthogonal transmittance (H₉₀) thereof, and the degree of polarization was calculated from the following expression: degree of polarization (%)={(H₀−H₉₀)/(H₀+H₉₀)}^{1/2}×100. The parallel transmittance (H₀) is a value of a transmittance of a parallel laminated polarizer formed by putting two identical polarizers onto each other so as to make their absorption axes parallel to each other. The orthogonal transmittance (H₉₀) is a value of a transmittance of an orthogonal laminated polarizer formed by putting two identical polarizers onto each other so as to make their absorption axes orthogonal to each other. These transmittances are each the Y value of tristimulus values based on the two-degree field according to JIS Z 8701-1995.

(3) Method for Measuring Birefringence Index (Δn_{xy}[λ]) of Polarizer:

The birefringence index was measured by using a retardation measurement device (trade name: “KOBRA-31X100/IR” manufactured by Oji Scientific Instruments) at wavelength of 1000 nm and 23° C.

### (4) Method for Measuring Content of Each of Elements (I and K)

A circular sample having a diameter of 10 mm was measured by fluorescent X-ray analysis under conditions described below. From the resultant of X-ray intensity, the content of each of the elements was calculated on the basis of a calibration curve prepared in advance by use of a standard sample.

Analysis device: fluorescent X-ray analyzer (XRF), Product name: “ZSX 100e”, manufactured by Rigaku Corporation.

Counter cathode: rhodium

Dispersive crystal: lithium fluoride

Exciting light energy: 40 kV·90 mA

Iodine measuring ray: I-LA

Potassium measuring ray: K-KA

Quantity measuring method: FP method

2θ angle peak: 103.078 degrees (iodine), 136.847 degrees (potassium)

Measuring period: 40 seconds

### (5) Method for Measuring Neck-in Ratio:

The neck-in ratio (NR) was calculated from NR={(Wo−W)/Wo}×100 by measuring each of the width of the film before being drawn (Wo) and the width of the film after being drawn (W).

### (6) Method for Measuring Retardation Values (Re[λ] and Rth[λ]):

The retardation value was measured by using a product (trade name: “KOBRA 21-ADH” manufactured by Oji Scientific Instruments) at wavelength of 590 nm and 23° C. The used average refractive index was a value measured with an Abbe refractometer [trade name: “DR-M4”, manufactured by Atago Co., Ltd.].

### (7) Method for Measuring Thickness:

When the thickness was less than 10 μm, a spectrophotometer for thin films [product name: “SHUNKAN [transliteration] MULTI PHOTOMETRY SYSTEM MCPD-2000”, manufactured by Otsuka Electronics Co., Ltd.] was used to measure the thickness. When the thickness was 10 μm or more, a digital micrometer “KC-351C model” manufactured by Anritsu Corporation was used to measure the thickness.

### (8) Method for Measuring Contrast Ratio in Liquid Crystal Display:

The contrast ratio was measured by using a product (product name: “EZ Contrast 160D”) manufactured by Eldim Company after 30 minutes passed from a time when its backlight was turned on in a dark room at 23° C., and measured the Y values in the XYZ display system at an azimuth angle from 0° to 360° and a polar angle of 60° in a display screen when a white image and a black image were displayed. From the Y value (YW) of the white image and the Y value (YB) of the black image, the contrast ratio (YW/YB) in the oblique direction was calculated out. Here, the long sides of the liquid crystal panel was set to an azimuth angle of 0°, and the normal direction thereof was set to a polar angle of 0°.

[Production Example of Continuous Polarizer (a1)]

A continuous film [trade name “VF-PS#7500”, manufactured by Kuraray Co., Ltd., a width of 3400 mm and a thickness of 75 μm] containing polyvinyl alcohol-based resin as the main component was prepared. This continuous film was immersed in five baths of the following (1) to (5) while tension was applied in a film longitudinal direction, and drawn so that the final draw ratio was 4.5 times with respect to the original length of the film and the neck-in ratio was 50%. This drawn film was dried in an air-circulating drying oven at a temperature of 60° C. for one minute to produce a continuous polarizer (a1). The produced continuous polarizer (a1) had a width of 1700 mm and a thickness of 40 μm. The properties of this continuous polarizer (a1) are shown in Table 1.

(1) Swelling bath: pure water at a temperature of 30° C.

(2) Dyeing bath: aqueous solution at a temperature of 30° C.

containing 0.038 parts by mass of iodine with respect to 100 parts by mass of water and 0.2 parts by mass of potassium iodide with respect to 100 parts by mass of water.

(3) First crosslinking bath: aqueous solution at a temperature of 40° C. containing 3 parts by mass of potassium iodide with respect to 100 parts by mass of water and 3 parts by mass of boric acid with respect to 100 parts by mass of water.

(4) Second crosslinking bath: aqueous solution at a temperature of 60° C. containing 5 parts by mass of potassium iodide with respect to 100 parts by mass of water and 4 parts by mass of boric acid with respect to 100 parts by mass of water.

(5) Washing bath: aqueous solution at a temperature of 25° C. containing 3 parts by mass of potassium iodide with respect to 100 parts by mass of water.

Production Example of Continuous Polarizer (a2)

A continuous polarizer (a2) was produced by the same method as in the above production example of the continuous polarizer (a1) except that the additive amount of iodine was 0.025 parts by mass with respect to 100 parts by mass of water in the dyeing bath, and the drawing was performed so that the final draw ratio was 6.0 times with respect to the original length of the film and the neck-in ratio was 65%. The produced continuous polarizer (a2) had a width of 1300 mm and a thickness of 25 μm. The properties of this continuous polarizer (a2) are shown in Table 1.

TABLE 1

| | Continuous | Continuous |
|---|---|---|
| | polarizer(a1) | polarizer(a2) |
| Final draw ratio (times) | 4.5 | 6.0 |
| Neck-in ratio (%) | 50 | 65 |
| Width (mm) | 1700 | 1300 |
| Single transmittance (%) | 38.5 | 42.2 |
| Degree of polarization (%) | 99.99 | 99.99 |
| Iodine content (% by mass) | 4.7 | 2.7 |
| Potassium content (% by mass) | 1.2 | 0.7 |
| Δn_{xy}[1000] | 0.017 | 0.033 |

Production Example of Continuous Retardation Film (b1)

A rolled polymeric film containing the norbornene-based polymer [trade name “ZEONOR ZF14-100”, manufactured by OPTES INC., a width of 600 mm and a thickness of 100 μm) was prepared. This polymeric film was drawn by 2.7 times in an air-circulating thermostatic oven at a temperature of 150° C. with the use of a tenter drawing machine by a fixed-end lateral uniaxial drawing method (a method to be fixed in a longitudinal direction and drawn in a width direction) to produce a continuous retardation film (b1). The produced continuous retardation film (b1) had a width of 1800 mm and a thickness of 35 μm. The properties of this continuous retardation film (b1) are shown in Table 2.

Production Example of Continuous Retardation Film (b2)

The drawing was performed in the same manner as in the above production example of the continuous retardation film (b1) except for replacing the above polymeric film containing a norbornene-based polymer with a rolled polymeric film (a thickness of 80 μm) containing a cellulose-based polymer (degree of acetyl substitution (DSac)=0.04, degree of propionyl substitution (DSpr)=2.76) to produce a continuous retardation film (b2). The produced continuous retardation film (b2) had a thickness of 40 μm.

Production Example of Retardation Film (b3)

Polyimide (6FDA/TFMB) was dissolved in methyl isobutyl ketone to prepare 15% by mass-polyimide solution. The above polyimide was obtained by reacting 2,2′-bis(3,4-dicarboxyphenyl)hexafluoropropanoic dianhydride with 2,2-bis(trifluoromethyl)-4,4′-diaminobiphenyl.

This polyimide solution was cast uniformly so as to be film form on the surface of a triacetylcellulose film (a thickness of 80 μm) with a slot die coater. Next, this was charged into a multi-chamber type air-circulating drying oven, and then the solvent was vaporized while heated up gradually from low temperature, namely, at a temperature of 80° C. for 2 minutes, at a temperature of 135° C. for 5 minutes and at a temperature of 150° C. for 10 minutes to form a polyimide layer on the triacetylcellulose film. This polyimide layer was sufficiently larger in size than a rectangle having a diagonal line of 40-inch, and used as a retardation film (b3). Here, in the case of using the polyimide layer (retardation film (b3)), this was peeled off the triacetylcellulose film. The properties of the retardation film (b3) thus produced are shown in Table 2.

TABLE 2

| | Retardation film(b1) | Retardation film(b3) |
|---|---|---|
| Index ellipsoid | nx > ny > nz | nx = ny > nz |
| Thickness (μm) | 35 | 3.7 |
| T[590](%) | 91 | 90 |
| Re[590](nm) | 120 | 1 |
| Rth[590](nm) | 160 | 150 |
| Nz coefficient | 1.33 | — |

### Example 1

The above continuous retardation film (b1) was laminated on one surface of the above continuous polarizer (a1) through a water-soluble adhesive layer (a thickness of 1 μm) containing a polyvinyl alcohol-based polymer [trade name “GOHSEFIMER Z200”, manufactured by Nippon Synthetic Chemical Industry Co., Ltd.] as the main component interposed therebetween. However, the continuous retardation film (b1) was disposed so that the slow axis direction of the retardation film (b1) was at an angle of approximately 90° with the absorption axis direction of the continuous polarizer (a1).

On the other hand, a triacetylcellulose film having a thickness of 80 μm was laminated on the other surface of the above continuous polarizer (a1) through the same water-soluble adhesive layer (a thickness of 1 μm) interposed therebetween. In this way, a continuous optical laminated film having a width of 1700 mm was produced. This continuous optical laminated film was die-cut into a rectangle having a diagonal line of 40-inch with a Thomson blade to produce a rectangular optical laminated film (x1).

### Example 2

Each of the films was laminated in the same manner as in Example 1 except for replacing the continuous retardation film (b1) with the continuous retardation film (b2) to produce a continuous optical laminated film having a width of 1700 mm. This continuous optical laminated film was die-cut into a rectangle having a diagonal line of 40-inch with a Thomson blade to produce a rectangular optical laminated film (x2).

### Comparative Example

Each of the films was laminated in the same manner as in Example 1 except for replacing the continuous polarizer (a1) with the continuous polarizer (a2) to produce a continuous optical laminated film having a width of 1300 mm. This continuous optical laminated film was die-cut into a rectangle having a diagonal line of 40-inch with a Thomson blade to produce a rectangular optical laminated film (x3).

### Evaluation test of Example 1

A liquid crystal panel was taken out of a commercial liquid crystal display including a liquid crystal cell in VA mode [trade name “BRAVIA KDL-40X1000”, a liquid crystal television having a diagonal screen of 40-inch manufactured by Sony Corporation], and all optical films such as a polarizing plate disposed above and below the liquid crystal cell were removed. The front and back of the glass plate of this liquid crystal cell were washed.

The above optical laminated film (x1) of Example 1 was adhered on the viewing side of the obtained liquid crystal cell through an acryl-based pressure-sensitive adhesive layer interposed therebetween. However, the optical laminated film (x1) was disposed so that the retardation film (b1) laminated on this optical laminated film (x1) is faced the liquid crystal cell. In addition, the optical laminated film (x1) was disposed so that the absorption axis direction of the polarizer (a1) laminated on the optical laminated film (x1) was parallel to the continuous side direction of the liquid crystal cell.

On the other hand, the above retardation film (b3) was adhered on the backlight side of the above liquid crystal cell through an acryl-based pressure-sensitive adhesive layer interposed therebetween. In addition, a commercial polarizing plate [trade name “NPF-SEG1224DU”, manufactured by Nitto Denko Corporation] was adhered on the surface opposite to the adhesive surface of the retardation film (b3) to the liquid crystal cell through an acryl-based pressure-sensitive adhesive layer interposed therebetween. However, the commercial polarizing plate was disposed so that the absorption axis direction of this commercial polarizing plate was orthogonal to the continuous side direction of the liquid crystal cell.

The liquid crystal panel thus produced was joined with the backlight unit of the original liquid crystal display to constitute a liquid crystal display (y1) of Example 1.

When the display properties of this liquid crystal display (y1) were measured, contrast ratio in a front direction was 1280 and contrast ratio in oblique direction was 66.

### Evaluation Test of Example 2

A liquid crystal panel was produced in the same manner as in the above evaluation test of Example 1 except for replacing the optical laminated film (x1) with the optical laminated film (x2) of Example 2 to produce a liquid crystal display (y2) mounted with this liquid crystal panel.

When the display properties of this liquid crystal display (y2) were measured, contrast ratios in both a front direction and oblique directions were equal to the above liquid crystal display (y1) of Example 1.

### Evaluation Test of Comparative Example

A liquid crystal panel was produced in the same manner as in the above evaluation test of Example 1 except for replacing the optical laminated film (x1) with the optical laminated film (x3) of Comparative Example to produce a liquid crystal display (y3) mounted with this liquid crystal panel.

When the display properties of this liquid crystal display (y3) were measured, contrast ratio in a front direction was 950 and contrast ratio in oblique directions was 63.

The above results prove that the liquid crystal displays (y1) and (y2) provided with the optical laminated film (x1) of Example 1 and the optical laminated film (x2) of Example 2 respectively are excellent in contrast ratio.

1. An optical laminated film, comprising:
a polarizer; and
a retardation film laminated on one surface of the polarizer;
wherein the polarizer has a drawn film of a hydrophilic polymer containing a dichroic material;
an in-plane birefringence index (Δn_{xy[}1000]) of the polarizer at wavelength of 1000 nm is from 0.01 to 0.03; and
the retardation film is such that an index ellipsoid satisfies the relation of nx>ny≧nz and is disposed so that a slow axis direction of the retardation film is substantially orthogonal to an absorption axis direction of the polarizer.

2. The optical laminated film according to claim 1, wherein a single transmittance of the polarizer is 42% or less and a degree of polarization thereof is 98% or more.

3. The optical laminated film according to claim 1, wherein the retardation film is a drawn film containing a norbornene-based polymer or a cellulose-based polymer.

4. The optical laminated film according to claim 1, wherein an Nz coefficient of the retardation film is from 1.0 to 1.5.

5. The optical laminated film according to claim 1, wherein the polarizer and the retardation film are laminated through an adhesive layer interposed therebetween.

6. A method for producing a continuous optical laminated film, comprising the following steps 1 to 3:
the step 1: a step of drawing a continuous film (A) of a hydrophilic polymer containing a dichroic material to produce a continuous polarizer such that an in-plane birefringence index (Δn_{xy[}1000]) at wavelength of 1000 nm is from 0.01 to 0.03;
the step 2: a step of drawing a continuous film (B) at least in a width direction to produce a continuous retardation film such that an index ellipsoid satisfies a relation of nx>ny≧nz; and
the step 3: a step of laminating the continuous retardation film obtained in the step 2 on one surface of the continuous polarizer obtained in the step 1 to produce the continuous optical laminated film.

7. A liquid crystal display comprising the optical laminated film according to claim 1.
